(19) United States
(12) Patent Application Publication
(10) Pub. No.: US 2004/0243674 A1
(43) Pub. Date: Dec. 2, 2004

(54) System and method for message conversion

(75) Inventor: Kuan-Hung Lu, Tainan City (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/836,000

(22) Filed: Apr. 29, 2004

(30) Foreign Application Priority Data
May 29, 2003 (TW) 92114534

(51) Int. Cl. G06F 15/16

(52) U.S. Cl. 709/204

(57) ABSTRACT

A system of MMS message conversion. The system comprises an MMS message storage device and a conversion unit. The MMS message storage device stores an original MMS message having multiple simultaneous multimedia objects, and a converted MMS message. The conversion unit receives an original MMS message, adds multiple switching objects corresponding to the multimedia objects, inserts additional properties and values thereof into both switching objects and multimedia objects, resulting in activation of the multimedia object by the switching objects, and generates a converted MMS message.

### BACKGROUND OF THE INVENTION

1 . Field of the Invention

The present invention relates to message management, and more particularly to a method and system for Multimedia Messaging Service (MMS) message conversion.

2. Description of the Related Art

Communication devices, such as computers, cellular phones, PDA, or others, transfer not only text but multimedia messages. In order to properly recognize messages from various types of communication devices, many message exchange standards, such as the extensible markup language (XML), hypertext markup language (HTML), wireless Markup Language (WML) and synchronized multimedia integration language (SMIL) have been introduced. These standards use pairs of tags, such as <text> and </text>, to structure messages into text, hypertext links, videos, or others, thereby enabling a message parser to decode the structured messages. Much energy is spent developing powerful message parsers embedded in the communication devices for various message types.

In the past, WML was very popular format for wireless communication. As a result of increasing requirements for MMS, the World Wide Web Consortium (W3C) has established SMIL as an MMS message standard. This standard has also been adopted by the 3^{rd} Generation Partnership Project (3GPP) and the WAP forum. All content providers expect that communication devices can fully handle the SMIL standard. It is recommended by 3GPP, however, to consider small displays and simple input devices when authoring SMIL messages. Several SMIL message authoring guidelines are introduced in Annex B of the 3GPP TS 26.234 V5.1.0.

Several limitations exist due to hardware restrictions on mobile devices. Operations such as displaying multiple images, or playing multiple video files simultaneously, are difficult to achieve. Such full-featured MMS messages result in unexpected errors on most mobile devices. To address this situation, mobile devices may ignore this kind of message, or display only a first image or video file when received, to avoid errors. In view of the limitations of hardware restrictions above, a need exists for a system and method of MMS message conversion to enable new messages providing multimedia objects, such as image, audio, or video files, in sequence.

In addition, if a mobile device displays fully featured video, it is often preferable to disable some elements, such as audio or subtitles. This also requires conversion of original MMS messages to new messages enabling disability of some elements according to the settings.

SUMMARY OF THE INVENTION

It is therefore an object of the present invention to provide a system and method of message conversion to convert fully featured MMS messages to a new message enabling sequential display of multiple video files and disability of selected elements.

According to the invention, the system comprises a MMS message storage device, a configuration database, a conversion unit and a refreshing unit. The MMS message storage device stores an original MMS message having multiple simultaneous multimedia objects and a converted MMS message. The configuration database stores multiple configuration records that preferably include parameters and settings associated with a particular function. The conversion unit, configured to input the original MMS message and add multiple switching objects corresponding to the multimedia objects. After that, link properties and values thereof are inserted into each switching object, and trigger properties, configuration properties and values thereof are inserted into each multimedia object, thereby generating a converted MMS message. The refreshing unit issues a command to the conversion unit to activate MMS message conversion.

### BRIEF DESCRIPTION OF THE DRAWINGS

The present invention can be more fully understood by reading the subsequent detailed description and examples with references made to the accompanying drawings, wherein:

FIG. 1 is a diagram of the architecture of a system of message conversion according to the invention;

FIG. 2a is a diagram of an exemplary original MMS message according to an embodiment of the present invention;

FIG. 2b is a diagram of an exemplary converted MMS message according to an embodiment of the present invention;

FIG. 3 is a diagram of an exemplary configuration record according to an embodiment of the invention;

FIG. 4 is a flowchart showing a method of the MMS message conversion according to the invention;

FIG. 5 is a diagram of a storage medium for storing a computer program providing a method of the MMS message conversion according to the invention.

### DETAILED DESCRIPTION OF THE INVENTION

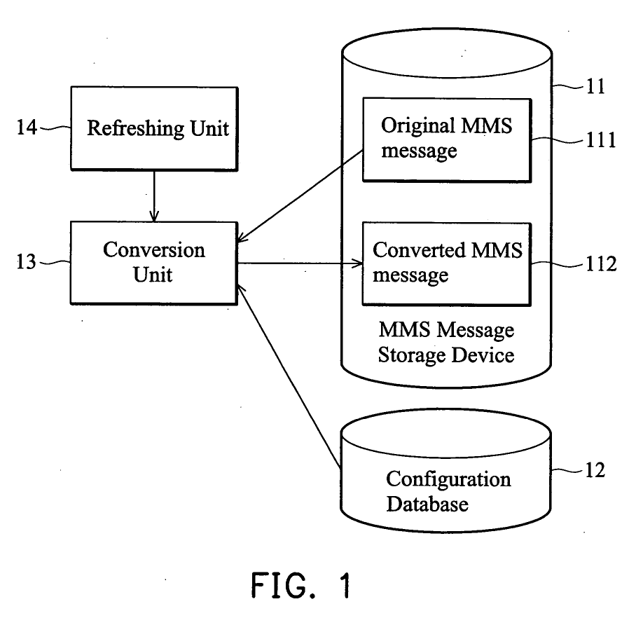

FIG. 1 is a diagram of the architecture of a system of message conversion according to the invention. The system includes a MMS message storage device 11, a configuration database 12, a conversion unit 13 and a refreshing unit 14.

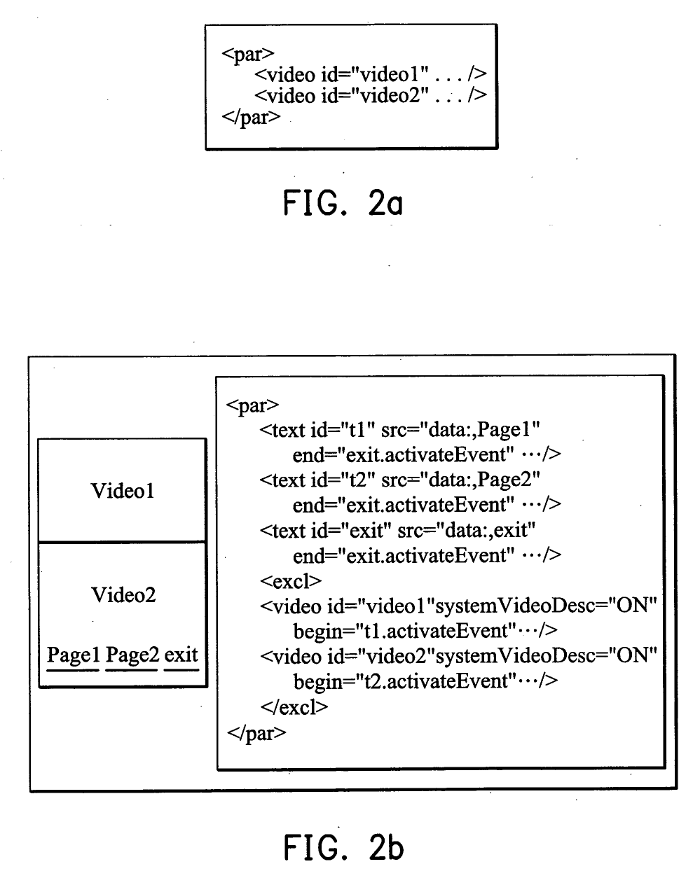

The MMS message storage device 11 stores an original MMS message 111 and a converted MMS message 112, and can be implemented in a disc or memory. FIG. 2a is a diagram of an exemplary original MMS message according to an embodiment of the present invention. The original MMS message 111 has two video objects, video1 and video2. FIG. 2b is a diagram of an exemplary converted MMS message according to the embodiment of the present invention.

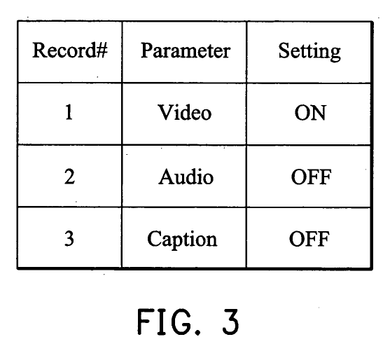

The configuration database 12 can be implemented in a memory, relational database, such as Oracle, DB2, SQL, or other object database or file to store multiple configuration records. The configuration record preferably includes parameters and settings associated with the particular function. For example, for a video file having three parts, subtitles, audio, and video, the configuration records represent settings for execution of each element of the video file. FIG. 3 is a diagram of an exemplary configuration record according to the invention. Three records are included, in record 1, a video parameter is set to “ON” and the others are set to “OFF”, such that the communication device displays only video without audio or subtitles. Consistent with the scope and spirit of the invention, additional or different fields may be provided.

The conversion unit 13 inputs the original MMS message 111, as shown in FIG. 2a, from the MMS message storage device. It is necessary to calculate the number of simultaneous multimedia objects first for separation. In a synchronized multimedia integration language (SMIL) message, for example, all of simultaneous multimedia objects are bracketed by a pair of tags, <par> and </par>. In FIG. 2a, two video files, <video id=“video1” . . . /> and <video id=“video2” . . . />, are bracketed between <par> and </par>. The number of simultaneous multimedia objects calculated is 2. Accordingly, the conversion unit 13 inserts two text buttons, <text id=“p1” . . . /> and <text id=“p2” . . . />, as switching objects into the original MMS message 111, enabling users to select a particular video file for display. Switching objects are not limited to text buttons, being available as well as graphic buttons or others. Next, a link property in each switch object is provided to link to a particular multimedia object. Methods in link setup differ with various types of MMS message. In SMIL, multimedia objects are embedded in a page object, thus, the text button must provide an “src” property and assign a page object containing a multimedia object as a value to the “src” property for linkage, for example, <text id=“t1”src=“data:,Page1” . . . />. In addition, the video object must be provided with a “begin” property and be assigned an activation event associated with the particular text button as a value to activate the begin property, such as <video id=“video1”begin=“p1.activateEvent” . . . />. The conversion unit 13 reads the configuration record from the configuration database 12, and accordingly provides relevant properties and values thereof, for example, <video id=“video1”systemVideoDesc=“ON” . . . />. In SMIL, the multimedia objects must be bracketed between <excl> and </excl> enabling the communication device to display each multimedia object individually. Thus, the conversion unit 13 brackets two video objects between <excl> and </excl>. Finally, the converted MMS message 112 is generated as shown in FIG. 2b, having two video objects, video1 and video2, and two text buttons, t1 and t2. Each video object provides configuration properties and values thereof are set according to the configuration database 12. Each text button has an event to trigger activation to display the particular video object.

The refreshing unit 14 issues a command to the conversion unit 13 for MMS message-re-conversion. After completing the configuration records and storing to the configuration database 12, the refreshing unit launches the conversion unit 13 to regenerate the converted MMS message 112 according to the new settings.

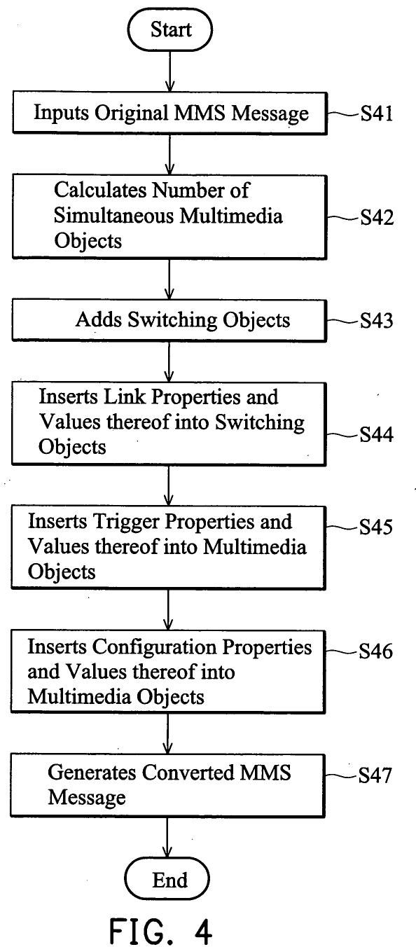

FIG. 4 is a flowchart showing a method of MMS message conversion according to the invention.

First, in step S41, the original MMS message as shown in FIG. 2a is input by the conversion unit 13.

In step S42, the number of simultaneous multimedia objects is calculated, varying with different message types, such as SMIL.

In step S43, switching objects, such as text, graphic buttons, or others are inserted into the original MMS message, according to the result calculated in step S42.

In step S44, link properties, such as src or others, are inserted into the switching objects, and values thereof are set to the relevant multimedia objects.

In step S45, trigger properties, such as begin or others, are inserted into the multimedia objects, and values thereof are set to the relevant activation events associated with the switching objects.

In step S46, configuration properties, such as “systemVideoDesc”, “systemAudioDesc”, “systemCaptionDesc” or others, and values thereof, are inserted into the multimedia objects according to the configuration records as shown in FIG. 3.

Finally, in step S47, the converted MMS message 112 as shown in FIG. 2b is generated according to the above steps.

Although the order of the method has been described in a preferred embodiment, it is not intended to limit the method to the precise order disclosed herein. Those skilled in the technology can perform variations without departing from the scope and spirit of this invention.

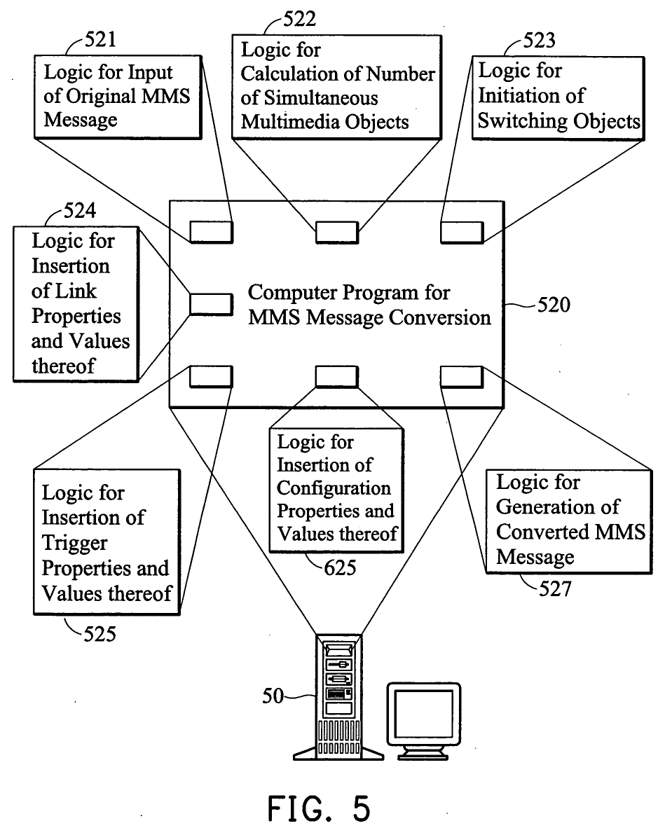

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits. The storage medium is shown in FIG. 5.

The system and method of this invention converts an original MMS message having multiple simultaneous multimedia objects to a converted MMS message having additional switching objects and activation links therefor, thereby enabling communication devices to display each multimedia object when a key associated with a switch object on the keypad is used, overcoming hardware restrictions. In addition, the converted MMS message also enables the device to dynamically disable individual functions according to the settings.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system of Multimedia Messaging Service (MMS) message conversion, comprising:
a MMS message storage device capable of storing an original MMS message having a plurality of simultaneous multimedia objects; and
a conversion unit, configured to receive the original MMS message, to add a plurality of switching objects corresponding to the multimedia objects, insert a link property and value thereof into each switching object to connect the multimedia object, insert a trigger property and value thereof into each multimedia object to activate the multimedia object, and thereby generate a converted MMS message.

2. The system as claimed in claim 1 wherein the original MMS message is a SMIL message.

3. The system as claimed in claim 1 wherein the converted MMS message is a SMIL message.

4. The system as claimed in claim 1 wherein the switch object is a text button or a graphic button.

5. The system as claimed in claim 1 wherein the multimedia object is an image or video file.

6. The system as claimed in claim 1 further comprising a configuration database capable of storing a configuration record, comprising parameters and settings.

7. The system as claimed in claim 6 wherein, in the configuration database, parameters comprise audio, caption, or video information.

8. The system as claimed in claim 6 wherein the conversion unit further inserts a configuration property and value thereof into the multimedia object according to the configuration record.

9. The system as claimed in claim 8 further comprising a refreshing unit issuing a command to the conversion unit for MMS message re-conversion.

10. A method of MMS message conversion, comprising using an electronic device having a CPU to perform the steps of:
inputting an original MMS message having a plurality of simultaneous multimedia objects;
adding a plurality of switching objects corresponding to the multimedia objects;
inserting a link property and value thereof into each switching object for multimedia object linkage;
inserting a trigger property and value thereof into each multimedia object for multimedia activation; and
generating a converted MMS message having switching objects and the final revised multimedia objects.

11. The method as claimed in claim 10, wherein the original MMS message is a SMIL message.

12. The method as claimed in claim 10, wherein the converted MMS message is the SMIL message.

13. The method as claimed in claim 10, wherein the switch object is a text button or a graphic button.

14. The method as claimed in claim 10, wherein the multimedia object is an image or a video file.

15. The method as claimed in claim 10 further comprising inputting a configuration record comprising parameters and settings.

16. The method as claimed in claim 15, wherein the parameter is a video, an audio or a caption.

17. The method as claimed in claim 15 further comprising inserting a configuration property and value thereof into the multimedia object according to the configuration record.

18. A storage medium for storing a computer program, wherein the computer program, applied in an electronic device having a CPU, executes the method claimed in claim 10.
